(19) United States
(12) Patent Application Publication
(10) Pub. No.: US 2002/0067825 A1
(43) Pub. Date: Jun. 6, 2002

(54) INTEGRATED HEADPHONES FOR AUDIO PROGRAMMING AND WIRELESS COMMUNICATIONS WITH A BIASED MICROPHONE BOOM AND METHOD OF IMPLEMENTING SAME

(76) Inventors: ROBERT BARANOWSKI, SAN DIEG0, CA (US); ROGER WILLIAM BERG, CARLSBAD, CA (US)

Correspondence Address: RONALD P KANANEN, RADER FISHMAN & GRAUER PLLC, 1233 20TH STREET N W, SUITE 501, WASHINGTON, DC, 20036

(21) Appl. No.: 09/401,315

(22) Filed: Sep. 23, 1999

(51) Int. Cl. H04M 1/00; H04M 9/00

(52) U.S. Cl. 379/430

(57) ABSTRACT

A headset can be used to listen to music or other audio programming and can also be used conduct a telephone conversation. A microphone on a biased arm pivots between an extended position and a retracted position so as to be in place for conducting a telephone call, but out of the way when not in use. Extension of the microphone arm may signal the acceptance of an incoming call or may initiate a call being placed by the user.

### FIELD OF THE INVENTION

The present invention relates to the field of headphones or headsets for listening to audio programming. The present invention also relates to the field of wireless or cordless telephony. More specifically, the present invention relates to a headset or set of headphones that can be used for both listening to audio programming and interfacing with a wireless or cordless telephone unit.

### BACKGROUND OF THE INVENTION

Headphones or headsets have long been used as a means of privately listening to audio programming, particularly music. Such headphones are commonly capable of producing extremely high quality audio. Headphones can be used with a radio tuner, a compact disc or tape player, a personal stereo, a television, a larger shelf or home stereo, a computer or any other device outputting an audio signal.

Headphones are conventionally connected to an audio signal source with a wire that provides a separate stereo signal to each of the two speakers located respectively over the user's two ears. The speakers may be held in place by a band that rests over the top of the user's head. Alternatively, the speakers may be individually secured in, or on, the user's ears.

An emerging technology allows headphones to wirelessly receive an audio signal from an audio signal source without a wire-line connection to the audio signal source. This allows the user to move around freely within a range of the audio signal source and still enjoy the audio programming being provided through the headphones.

In another field, cordless and wireless telephony similarly allow users to make and receive telephone calls from anywhere within a range of the cordless base set or within a wireless service area. Some cordless phones also make use of a headset. For example, a headset, e.g., a pair of headphones or an ear-piece secured to or on one the user's ears, may be wired to a cordless telephone handset to allow the wearer to hear the incoming audio signal of a phone call. A microphone mounted on the headset allows the user to speak in response and, thereby, conduct a telephone call. The same arrangement may be available with a wireless or cellular telephone handset. Additionally, the headset may communicate wirelessly with the handset.

The use of headsets for listening to audio programming and for conducting wireless or cordless telephone calls have now converged. In a related patent application, U.S. Ser. No. 08/950,833, filed Oct. 15, 1997 (incorporated herein by reference in its entirety), it was suggested that a single pair of headphones could be used for both enjoying audio programming from an audio signal source and conducting a cordless telephone call. However, problems remain integrating, into a single pair of headphones, the functions of providing high quality audio programming and conducting a telephone call. For example, when conducting a telephone call, the user must be provided with a microphone into which he or she can speak. However, the presence of such a microphone is unnecessary and, perhaps, annoying when the user merely wishes to listen to audio programming.

Consequently, there is need in the art for an improved headset that selectively allows the user to have a microphone available when conducting a telephone call, but prevents, as much as possible, the microphone from being in the way when it is not in use.

### SUMMARY OF THE INVENTION

It is an object of the present invention to meet the above-described needs and others. Specifically, it is an object of the present invention to provide an improved headset that selectively allows the user to have a microphone available when conducting a telephone call, but prevents the microphone from being in the user's way when it is not in use.

Additional objects, advantages and novel features of the invention will be set forth in the description which follows or may be learned by those skilled in the art through reading these materials or practicing the invention. The objects and advantages of the invention may be achieved through the means recited in the attached claims.

To achieve these stated and other objects, the present invention may be embodied and described as a headset for listening to music or other audio programming, and for conducting telephonic communications. The headset preferably includes: at least one speaker; a communications link to an audio signal source to provide the audio programming; a communications link to a telephone unit; and a microphone provided on a microphone arm. The microphone arm is connected to, and pivots with respect to, the speaker between an extended position and a retracted position.

Preferably, the microphone arm is biased to the extended position. Consequently, the headset may then include a latch for latching the microphone arm in the retracted position against the bias. Preferably, release of the latch automatically activates the communications link to the telephone unit. Alternatively, arrival of the microphone arm at the extended position may automatically activate the communications link to the telephone unit.

The communications link to a telephone unit may include an antenna. If this is the case, the antenna may automatically retract into a recess in the headset when the microphone arm moves from the extended position to the retracted position. Conversely, the antenna may automatically extend from the recess when the microphone arm moves from the retracted position to the extended position.

Preferably, the telephone unit is provided with a speech recognition system. This allows a user to initiate a phone call by activating the link between the headset and the telephone unit, and speaking a designation of the telephone number or party to be called. Additionally, a remote control unit, preferably separate, or separable, from the headset, can be used for controlling the audio signal source, the telephone unit or both.

The communications link to the telephone unit may be wired or wireless. The telephone unit may be a standard telephone unit, a cordless telephone base unit or a wireless telephone unit in communication with a wireless telephone service system. Similarly, the communications link to the audio signal source may be a wired or wireless link.

The present invention also encompasses a method of using a headset having at least one speaker for listening to music or other audio programming, and for also conducting telephonic communications. The method may be described as: providing, from the headset, a communications link to an audio signal source to provide the audio programming; providing, from the headset, a communications link to a telephone unit; and rotating a microphone on a microphone arm between an extended position and a retracted position as needed for telephonic communications.

### BRIEF DESCRIPTION OF THE DRAWINGS

The accompanying drawings illustrate the present invention and are a part of the specification. Together with the following description, the drawings demonstrate and explain the principles of the present invention.

FIG. 1 illustrates an embodiment of the present invention in which the microphone arm is retracted.

FIG. 2 illustrates another view of the embodiment of the present invention shown in FIG. 1, in which the microphone arm is released.

FIG. 3 illustrates a second embodiment of the present invention.

### DETAILED DESCRIPTION OF THE PREFERRED EMBODIMENTS

Using the drawings, the preferred embodiments of the present invention will now be explained.

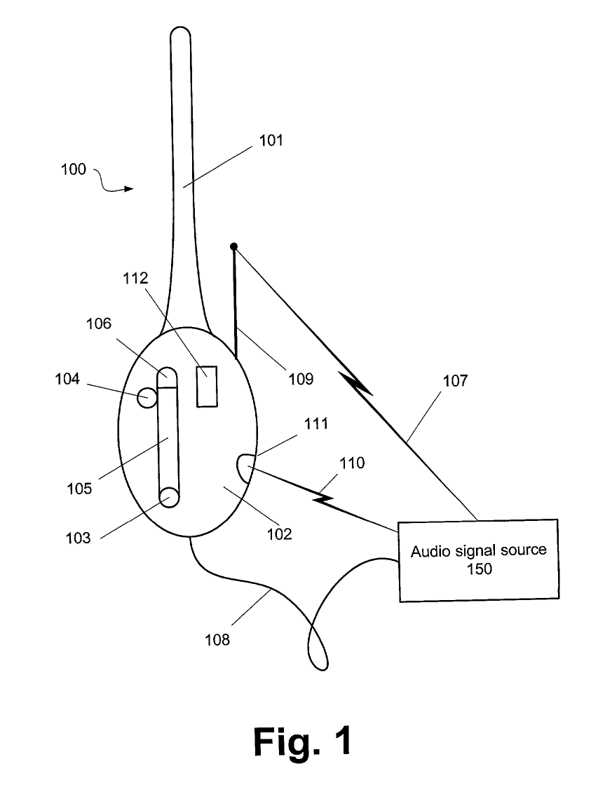

FIG. 1 illustrates a side view of a pair of headphones (100), according to the present invention, with which a user can both listen to audio programming and conduct a wireless, cellular or cordless telephone call. The headset (100) includes, for example, two stereo speakers (102) which are connected by a band (101) that is worn over a user's head when the speakers (102) are placed respectively over the user's ears. Alternatively, the present invention could be implemented in any form of headset, including a headset for which one or two speakers are hung or clipped to a user's ear or ears, or actually placed in the opening of user's ear or ears.

The headset (100) of the present invention can be used to listen to an audio signal from an audio signal source (150). The audio signal source (150) may be any device outputting an audio signal. For example, the audio signal source (150) may be, but is not limited to, a compact disc player, a cassette tape player, a radio tuner, a television, a computer, a video cassette recorder, a microphone, etc.

The audio signal may be transmitted from the audio signal source (150) to the headset (100) by a wired connection (108) or a wireless link (107 or 110). The wired connection (108) may be, for example, an electrical wire or a fiber optic cable. The wireless link (107) may be, for example, a radio frequency or optical transmission.

For wireless radio frequency communication, a radio antenna (109) would be provided on the headset (100) to receive the radio signal (107) from the audio signal source (150). Alternatively, for optical communication, a photodetector or optical signal detector (111), preferably in the infrared range, is provided on the headset (100) to receive corresponding optical transmissions (110) from the audio signal source (150).

The headset (100) of the present invention, can also be used to conduct a telephone conversation and, therefore, requires a microphone. During any period of time in which the headset (100) is used, as in FIG. 1, to listen to the audio signal source (150), the microphone should be provided in an unobtrusive location out of the way of the user. Consequently, under the principles of the present invention, the microphone (106) is provided at the end of an arm or boom (105). The arm (105) pivots around a fixed point (103) at which the arm (105) is physically connected to the headset (100).

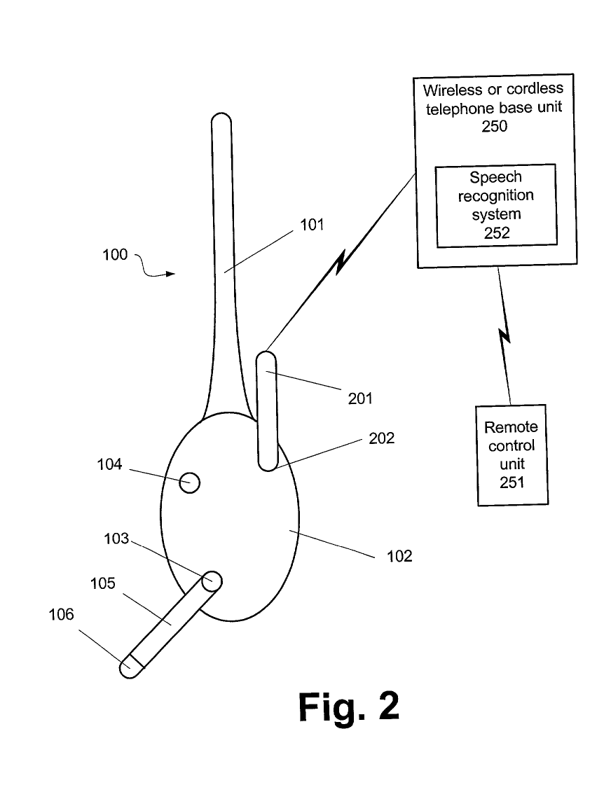

Preferably, the arm (105) is biased by, for example, a spring located at the pivot point (103). The arm is biased to rotate to the left (in FIG. 1) from the retracted position illustrated in FIG. 1 to the extended position illustrated in FIG. 2. A latch (104) is provided for holding the arm (105) in the retracted position against the biased pivot point (103). Preferably, when the arm (105) is rotated by the user into the retracted position shown in FIG. 1, the latch (104) is automatically engaged to hold the arm (105) in that position against the bias of the spring-loaded pivot point (103).

When the user wishes to receive or make a telephone call and, therefore, needs to extend the microphone arm (105), the user releases the latch (104), preferably by pressing the latch (104) into the housing of the speaker (102) so as to allow the arm (105) to swing freely down into the extended position illustrated in FIG. 2. Preferably, a catch (not shown), within the housing of the speaker (102), holds the latch (104) in a depressed position recessed into the speaker housing (102). When the arm (105) is rotated against the bias of pivot point (103) to the retracted position illustrated in FIG. 1, the catch is automatically released thereby allowing the latch (104) to spring back into an extended position from the speaker housing (102) so as to hold the arm (105) in the retracted position shown in FIG. 1. Alternatively, the user may need to again depress the latch (104) to pass the microphone arm (105) back into the retracted position of FIG. 1.

Additionally, the headphones (100) can be placed in an auto-answer mode. In this mode, when an incoming telephone call is signaled, the latch (104) is automatically released, allowing the arm (105) to swing the microphone (106) into position at the user's mouth under the bias of pivot point (103). The incoming telephone call is thus automatically connected to the headphones (100) and answered while the user's hands remain entirely free. A switch (112) may be provided on the headphones (100) for switching the headphones (100) into and out of the auto-answer mode.

As shown in FIG. 2, with the arm (105) in an extended position, the microphone (106) will be disposed near the mouth of a user so as to be available for conducting a telephone conversation. The headset (100) is in communication with a telephone base unit (250) for purposes of provided telephone service to a user of the headset (100). Preferably, the communication between the headset (100) and the base unit (250) is wireless. However, the headset (100) may be wired to the base unit (250).

The base unit (250) may be, for example, either a cordless telephone base unit that is wired to a public switched telephone network (PSTN), or a wireless or cellular telephone unit that wirelessly connects to the system of a wireless or cellular telephone service provider. Additionally, the base unit (250) may be a conventional telephone unit wired between the headset (100) and the PSTN.

While the headset (100) may use any wireless means of communicating with the base unit (250), including an optical signal, radio frequency communications are more conventional as in the cordless telephony field. Consequently, an antenna (201) is provided on the headset (100) for wireless communication with the base unit (250). If both the audio signal source (150) and the base unit (250) communicate using the same type of signal, the disclosed antennas (109 an 201) may be combined into a single antenna on the headset (100).

Additionally, to further decrease the protrusions from the headset (100) when the headset (100) is used to listen to the audio signal source (150), the antenna (201) may be retractable into the speaker housing (102). For example, if the headset (100) does not require an extended antenna (109) to communicate with the audio signal source (150), i.e., the headset (100) is wired (108) to the audio signal source (150) or communicates optically with the audio signal source via a photodetector (111) recessed into the housing of the speaker (102), the antenna (201) need only be extended when a telephone call is being received or made. Consequently, the antenna (201) is retracted into a recess (202) in the speaker housing (102) when not in use.

While the antenna (201) could be manually retracted and extended into and from the recess (202), preferably, the antenna (201) is physically connected to the microphone arm (105) such that the antenna (201) automatically extends when the arm (105) rotates to the position shown in FIG. 2 and automatically retracts when the arm (105) is rotated against the bias of pivot point (103) to the position shown in FIG. 1. Such concerted movement of the antenna (201) and arm (105) will be within the skill of the art given the disclosure of the present invention.

Also according to the present invention, the extension of the microphone arm (105) can be used to cause the connection of a telephone call being made or received. For example, if an indication is made to the user that a telephone call is incoming, e.g., the base unit (250) rings or the headset (100) rings, vibrates or emits an alert signal using the speaker (102) or another alert signal generator, the user then presses the latch (104) to release the microphone arm (105) to flip into to extended position of FIG. 2. The release of the latch (104) or the arrival of the arm (105) in the fully extended position of FIG. 2, can be used to activate a switch which automatically answers the incoming phone call with the headset (100), i.e., the microphone (106) and speakers (102) are brought into communication with the base unit (250) so as to conduct the incoming telephone call.

Similarly, if no incoming telephone call is being received, and the user releases the arm (105), the headset (100) may automatically signal the base unit (250) to open up a phone line and provide a dial tone so that a phone call can be placed. Again, the speakers (102) and microphone (105) are brought into communication with the base unit (250).

The user may then dial the number he or she wishes to call using, for example, a key pad on the base unit (250), a handset associated with the base unit (250) or a remote control unit (251) communicating with the base unit (250). If a remote control unit (251) is used, that remote control unit (251) may also be used to control the audio signal source (150) in the conventional manner.

Alternatively, the user may place a phone call by speaking a designation of the number to be called into the microphone (106). If the user speaks the number to be called or a pre-set identifier of the number, e.g. “call home,” a speech recognition system (252), preferably located at the base unit (250), will recognize the user's instruction and automatically place a call to the designated number.

Under the present invention, the user gains the optimal functionality from the headset so as to listen to music or other audio programming, while also being able to make and receive telephone calls. With the retractable microphone arm (105), the headset (100) is, at all times, rendered as compact and unobtrusive as possible. This goal is furthered by the potential retractability of the antenna used for telephonic communication. Consequently, the present invention provides a number of advantages from a novel combination of elements, which advantages are not available from prior art devices.

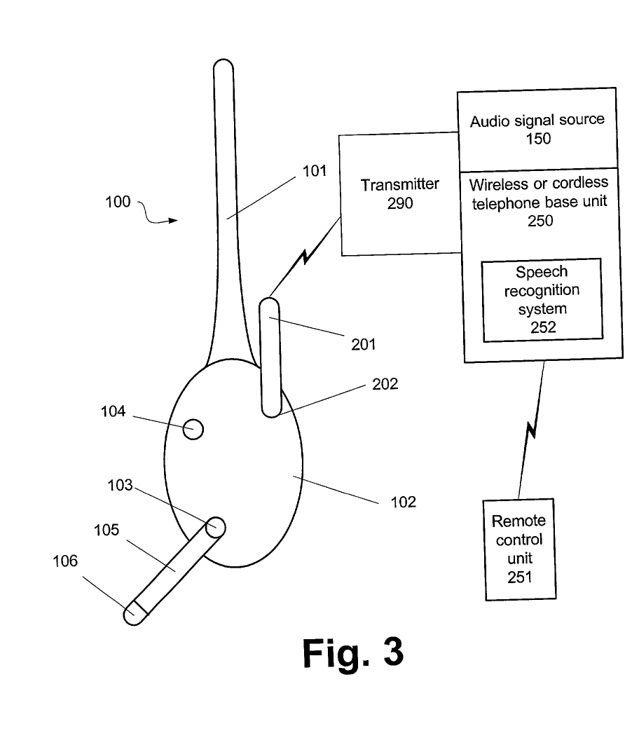

FIG. 3 illustrates another aspect of the present invention. As shown in FIG. 3, the audio signal source (150) and the wireless or cordless telephone base unit may be integrated into a single unit. This single unit provides a common transmitter (290) for communicating with the headphone unit (100). The transmitter (290) is thus shared by the audio signal source (150) and the telephone base unit (250).

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A headset for both listening to music or other audio programming, and for conducting telephonic communications, the headset comprising:
at least one speaker;
a communications link to an audio signal source to provide said audio programming;
a communications link to a telephone unit; and
a microphone provided on a microphone arm which is connected to, and pivots with respect to, said speaker between an extended position and a retracted position.

2. A headset as claimed in claim 1, wherein said audio signal source and said telephone unit are integrated into a single unit.

3. A headset as claimed in claim 1, wherein said microphone arm is biased to said extended position, said headset further comprising a latch for latching said microphone arm in said retracted position against said bias.

4. A headset as claimed in claim 3, wherein release of said latch automatically activates said communications link to a telephone unit.

5. A headset as claimed in claim 3, wherein said latch is automatically released in response to an incoming telephone call to allow said microphone arm to move to said extended position, said communications link to said telephone unit being activated in response to said incoming telephone call.

6. A headset as claimed in claim 1, wherein arrival of said microphone arm at said extended position automatically activates said communications link to a telephone unit.

7. A headset as claimed in claim 1, wherein said communications link to a telephone unit comprises an antenna.

8. A headset as claimed in claim 7, wherein said antenna automatically retracts into a recess in said headset when said microphone arm moves from said extended position to said retracted position, and automatically extends from said recess when said microphone arm moves from said retracted position to said extended position.

9. A headset as claimed in claim 1, wherein said telephone unit comprises a speech recognition system allowing a user to initiate a phone call by speaking a designation of a number or party to be called.

10. A headset as claimed in claim 1, further comprising a remote control unit for controlling either or both of said audio signal source and said telephone unit.

11. A headset as claimed in claim 1, wherein said communications link to said telephone unit is a wireless link.

12. A headset as claimed in claim 1, wherein said telephone unit is a wireless telephone unit in communication with a wireless telephone service system.

13. A headset as claimed in claim 1, wherein said telephone unit is a cordless telephone base unit.

14. A headset as claimed in claim 1, wherein said communications link to said audio signal source is a wireless link.

15. A method of using a headset with at least one speaker for listening to music or other audio programming, and for also conducting telephonic communications, the method comprising:
providing, from said headset, a communications link to an audio signal source to provide said audio programming;
providing, from said headset, a communications link to a telephone unit; and
rotating a microphone on a microphone arm between an extended position and a retracted position as needed for said telephonic communications.

16. A method as claimed in claim 15, further comprising:
biasing said microphone arm to said extended position; and
releasably latching said microphone arm in said retracted position against said bias with a latch.

17. A method as claimed in claim 16, further comprising automatically activating said communications link to said telephone unit in response to release of said latch.

18. A method as claimed in claim 15, further comprising automatically activating said communications link to said telephone unit in response to arrival of said microphone arm at said extended position.

19. A method as claimed in claim 15, wherein said communications link to a telephone unit comprises an antenna, and said method further comprises automatically retracting said antenna into a recess in said headset when said microphone arm moves from said extended position to said retracted position, and automatically extending said antenna from said recess when said microphone arm moves from said retracted position to said extended position.

20. A method as claimed in claim 15, further comprising:
recognizing, with a speech recognition system, a designation of a number or party to be called that is spoken into said microphone; and
initiating a call to that number or party.

21. A method as claimed in claim 15, further comprising controlling either or both of said audio signal source and said telephone unit with a single remote control unit.

22. A method as claimed in claim 15, wherein said communications link to said telephone unit is a wireless link.

23. A method as claimed in claim 15, wherein said telephone unit is a wireless telephone unit in communication with a wireless telephone service system.

24. A method as claimed in claim 15, wherein said telephone unit is a cordless telephone base unit.

25. A method as claimed in claim 15, wherein said communications link to said audio signal source is a wireless link.

26. A headset for both listening to music or other audio programming, and for conducting telephonic communications, the headset comprising:
at least one speaker means;
a communications means for communicating with an audio signal source to provide said audio programming;
a communications means for communication with a telephone unit; and
a means for providing vocal input to said headset, said means being disposed on a supporting means which is connected to, and pivots with respect to, said speaker means, said supporting means pivoting between an extended position and a retracted position.

27. A headset as claimed in claim 26, wherein said supporting means for said vocal input means are biased to said extended position, said headset further comprising a latch means for latching said supporting means in said retracted position against said bias.

28. A headset as claimed in claim 27, wherein release of said latch means automatically activates said communications means to a telephone unit.
